(19) United States
(12) Patent Application Publication
(10) Pub. No.: US 2025/0106029 A1
(43) Pub. Date: Mar. 27, 2025

(54) USER AUTHENTICATION SYSTEM CAPABLE OF GENERATING ONE-TIME PASSWORD HAVING FIXED EFFECTIVE PERIOD, AND STORAGE MEDIUM

(71) Applicant: KYOCERA Document Solutions Inc., Osaka (JP)

(72) Inventor: Hisakazu Nishiyama, Osaka (JP)

(21) Appl. No.: 18/900,084

(22) Filed: Sep. 27, 2024

(30) Foreign Application Priority Data
Sep. 27, 2023 (JP) 2023-166079

(51) Int. Cl. H04L 9/32; H04L 9/08

(52) U.S. Cl. CPC H04L 9/3228; H04L 9/0863; H04L 9/0869

(57) ABSTRACT

A user authentication system includes: generating a one-time password of a user based on a seed and a variable value of the user; notifying the generated one-time password; recording the variable value in a specific area such that the variable value becomes unusable after an elapse of a specific period; and executing, when the one-time password is input, confirmation of validity of the input one-time password based on the input one-time password, the seed of the user, and the variable value of the user recorded in the specific area.

### INCORPORATION BY REFERENCE

This application is based upon and claims the benefit of priority from the corresponding Japanese Patent Application No. 2023-166079 filed on Sep. 27, 2023, the entire contents of which are incorporated herein by reference.

### BACKGROUND

The present disclosure relates to a user authentication system which executes user authentication and a storage medium.

Conventionally, there has been known a method of generating one-time passwords (hereinafter, will be referred to as a “one-time password generation method”). The one-time password is generated based on a seed that is a fixed value generated for each user (private key) and a variable value that is changed every time a one-time password is generated. As the one-time password generation method, for example, HOTP (HMAC (Hash-based Message Authentication Code)-based One-Time Password) and TOTP (Time-based One-Time Password) are known.

HOTP is a one-time password generation method that uses, as the variable value, a counter value that is incremented by one every time authentication is executed.

TOTP is a one-time password generation method that uses, as the variable value, a counter value that is incremented by one every time a specific period such as 30 seconds elapses while a time at which the authentication is made effective is set as 0.

### SUMMARY

A user authentication system according to the present disclosure includes: generating a one-time password of a user based on a seed and a variable value of the user; notifying the generated one-time password; recording the variable value in a specific area such that the variable value becomes unusable after an elapse of a specific period; and executing, when the one-time password is input, confirmation of validity of the input one-time password based on the input one-time password, the seed of the user, and the variable value of the user recorded in the specific area.

A storage medium according to the present disclosure is computer-readable, the recording medium having recorded thereon a user authentication program for causing a computer to: generate a one-time password of a user based on a seed and a variable value of the user; notify the one-time password generated by the computer; record the variable value in a specific area such that the variable value becomes unusable after an elapse of a specific period; and execute, when the one-time password is input to the computer, confirmation of validity of the one-time password input to the computer based on the one-time password input to the computer, the seed of the user, and the variable value of the user recorded in the specific area.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram of a system according to an embodiment of the present disclosure;

FIG. 2 is a block diagram of a user device shown in FIG. 1 in a case where the user device is a PC;

FIG. 3 is a block diagram of an information processing system shown in FIG. 1 in a case where the information processing system is configured by a single computer;

FIG. 4 is a diagram showing an example of authentication information shown in FIG. 3;

FIG. 5 is a diagram showing an example of seed information shown in FIG. 3;

FIG. 6 is a diagram showing an example of mail address information shown in FIG. 3;

FIG. 7 is a diagram showing an example of a generation information recording area shown in FIG. 3;

FIG. 8 is a sequence diagram showing operations of the system shown in FIG. 1 in a case where a user logs in to the information processing system;

FIG. 9 is a sequence diagram for “one-time password generation” shown in FIG. 8;

FIG. 10 is a sequence diagram for “one-time password authentication” shown in FIG. 8;

FIG. 11 is a diagram showing an example of a login page that is displayed in the operations shown in FIG. 8;

FIG. 12 is a flowchart showing operations of an information management portion shown in FIG. 3 in a case where a combination of a seed, a variable value, and an expiration date is recorded in the generation information recording area;

FIG. 13 is a flowchart showing the operations of the information management portion shown in FIG. 3 in a case of deleting information with expired expiration date from the generation information recording area;

FIG. 14 is a diagram showing an example of an e-mail that is transmitted in the operations shown in FIG. 9; and

FIG. 15 is a diagram showing an example of a one-time password input page that is displayed in the operations shown in FIG. 9.

### DETAILED DESCRIPTION

Hereinafter, an embodiment of the present disclosure will be described with reference to the drawings.

First, a configuration of a system according to the embodiment of the present disclosure will be described.

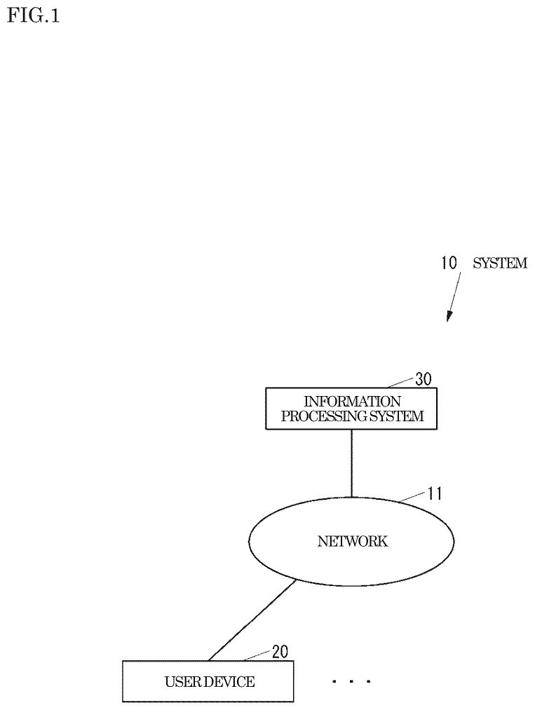

FIG. 1 is a block diagram showing a system 10 according to the present embodiment.

As shown in FIG. 1, the system 10 includes a user device 20 as an electronic device used by a user and an information processing system 30 that is accessed by the user device 20. The system 10 may include at least one user device that is similar to the user device 20 in addition to the user device 20.

The user device 20 may be configured by, for example, a PC (Personal Computer), a smartphone, a tablet, or the like.

The information processing system 30 may be realized by a single computer, or may be realized by a plurality of computers. The information processing system 30 may be arranged on a cloud.

The user device and the information processing system 30 in the system 10 can be connected to each other via, for example, a network 11 such as a LAN (Local Area Network) and the Internet.

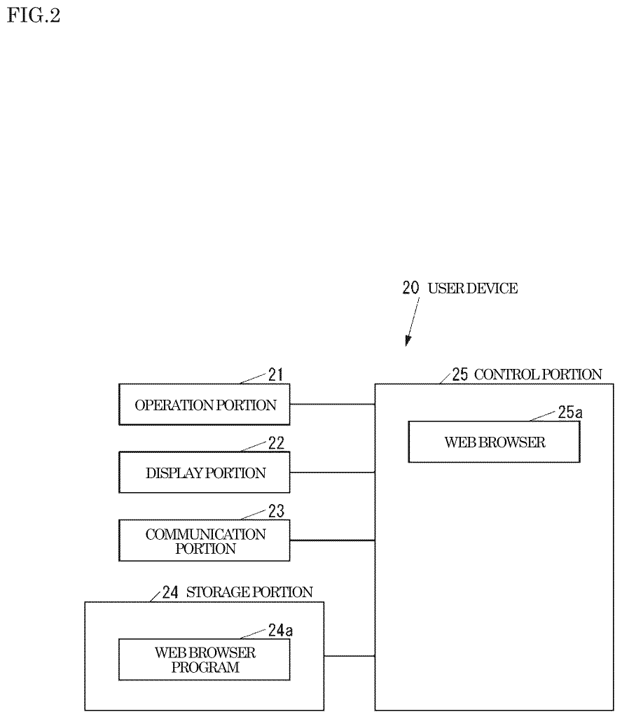

FIG. 2 is a block diagram of the user device 20 in a case where the user device 20 is a PC.

As shown in FIG. 2, the user device 20 includes an operation portion 21 which is an operation device to which various operations are input, such as a keyboard and a mouse, for example, a display portion 22 which is a display device that displays various types of information, such as an LCD (Liquid Crystal Display), for example, a communication portion 23 which is a communication device that performs communication with an external apparatus via a network such as a LAN and the Internet or directly by wires or wirelessly without using the network, a storage portion 24 which is a nonvolatile storage device that stores various types of information, such as a semiconductor memory and an HDD (Hard Disk Drive), for example, and a control portion 25 which controls the entire user device 20.

The storage portion 24 is capable of storing a program for a web browser (hereinafter, will be referred to as the “web browser program”) 24a. For example, the web browser program 24a may be installed in the user device 20 at a manufacturing stage of the user device 20, may be installed additionally in the user device 20 from an external storage medium such as a USB (Universal Serial Bus) memory, or may be installed additionally in the user device 20 from the network.

The control portion 25 includes, for example, a CPU (Central Processing Unit), a ROM (Read Only Memory) which stores programs and various types of data, and a RAM (Random Access Memory) as a memory that is used as a working area of the CPU of the control portion 25. The CPU of the control portion 25 executes the programs stored in the storage portion 24 or the ROM of the control portion 25.

The control portion 25 executes the web browser program 24a to realize a web browser 25a.

Incidentally, from the past, there has been known a method of generating one-time passwords (hereinafter, will be referred to as a “one-time password generation method”). The one-time password is generated based on a seed that is a fixed value generated for each user (private key) and a variable value that is changed every time a one-time password is generated. As the one-time password generation method, for example, HOTP (HMAC (Hash-based Message Authentication Code)-based One-Time Password) and TOTP (Time-based One-Time Password) are known.

HOTP is a one-time password generation method that uses, as the variable value, a counter value that is incremented by one every time authentication is executed.

TOTP is a one-time password generation method that uses, as the variable value, a counter value that is incremented by one every time a specific period such as 30 seconds elapses while a time at which the authentication is made effective is set as 0.

In HOTP, however, there is a problem that since the one-time password is not changed as long as authentication is not executed, an effective period of the one-time password is not constant. In addition, in TOTP, there is a problem that since the effective period of the one-time password is determined according to a timing at which the one-time password is generated during the specific period during which the variable value does not change, the effective period of the one-time password is not constant.

In contrast, in the system 10 according to the embodiment of the present disclosure, a one-time password having a fixed effective period can be generated as will be described below.

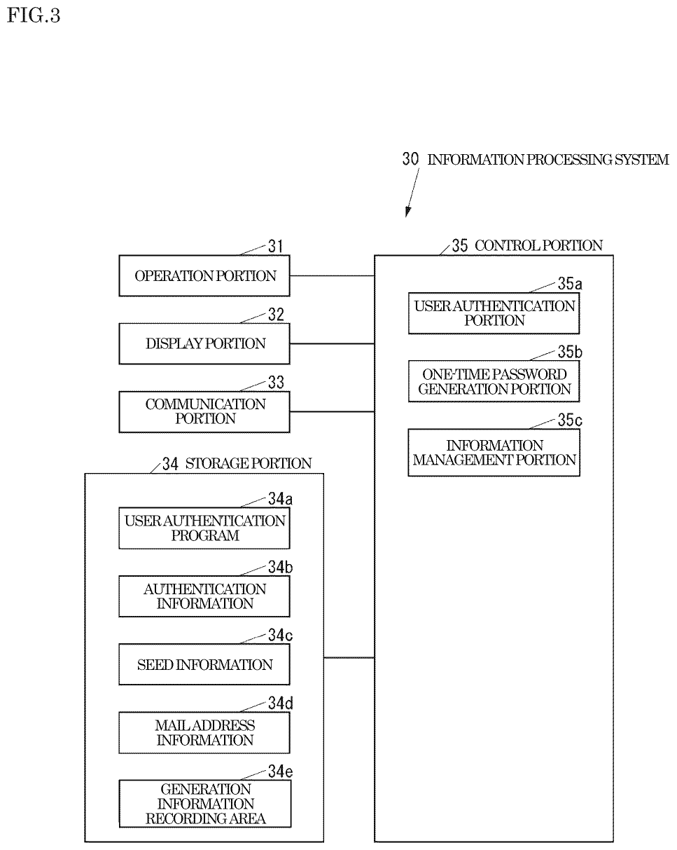

FIG. 3 is a block diagram of the information processing system 30 in a case where the information processing system 30 is configured by a single computer.

As shown in FIG. 3, the information processing system 30 includes an operation portion 31 which is an operation device to which various operations are input, such as a keyboard and a mouse, for example, a display portion 32 which is a display device that displays various types of information, such as an LCD, for example, a communication portion 33 which is a communication device that performs communication with an external apparatus via a network such as a LAN and the Internet or directly by wires or wirelessly without using the network, a storage portion 34 which is a nonvolatile storage device that stores various types of information, such as a semiconductor memory and an HDD, for example, and a control portion 35 which controls the entire information processing system 30.

The storage portion 34 is capable of storing a user authentication program 34a used for executing user authentication. For example, the user authentication program 34a may be installed in the information processing system 30 at a manufacturing stage of the information processing system 30, may be installed additionally in the information processing system 30 from an external storage medium such as a USB memory, or may be installed additionally in the information processing system 30 from the network.

The storage portion 34 stores authentication information 34b used for the user authentication.

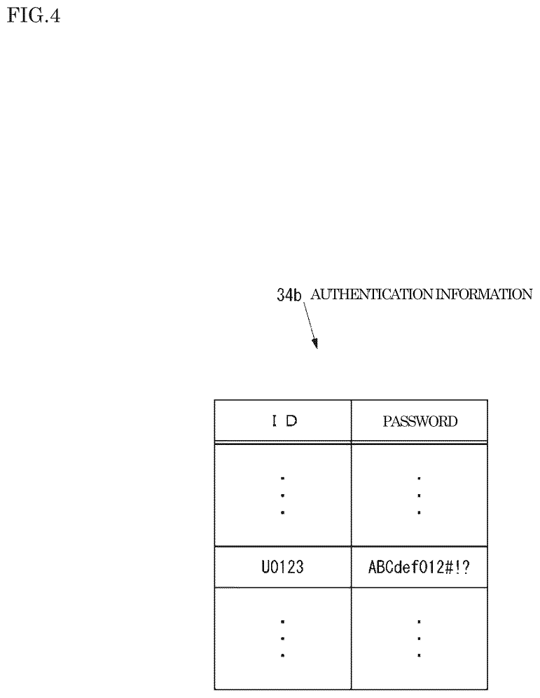

FIG. 4 is a diagram showing an example of the authentication information 34b.

The authentication information 34b shown in FIG. 4 shows, for each user, a combination of an ID as identification information of a user and a password of the user.

In FIG. 4, an illustration of IDs and passwords of users other than a user whose ID is “U0123” is omitted.

As shown in FIG. 3, the storage portion 34 stores seed information 34c that indicates a seed used for generating the one-time password.

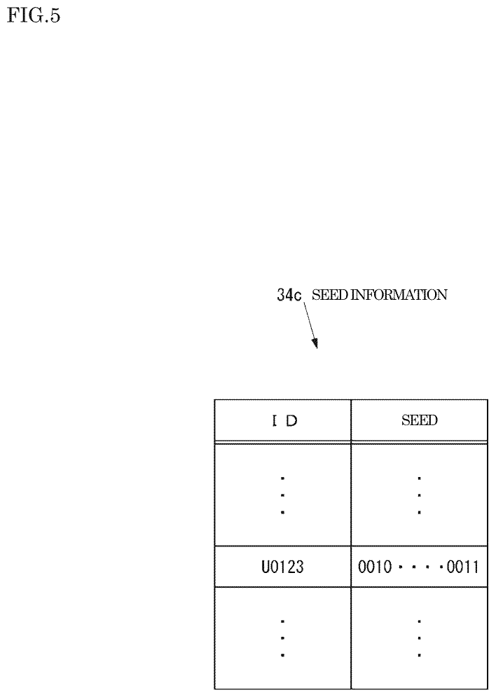

FIG. 5 is a diagram showing an example of the seed information 34c.

The seed information 34c shown in FIG. 5 shows, for each user, a combination of an ID and a seed of the user. The seed is a fixed value (private key), and is a value generated for each user. The value of the seed differs for each user.

In FIG. 5, an illustration of IDs and seeds of users other than the user whose ID is “U0123” is omitted. In FIG. 5, the seed of the user whose ID is “U0123” is illustrated while omitting a middle portion.

As shown in FIG. 3, the storage portion 34 stores mail address information 34d that indicates an e-mail address of the user.

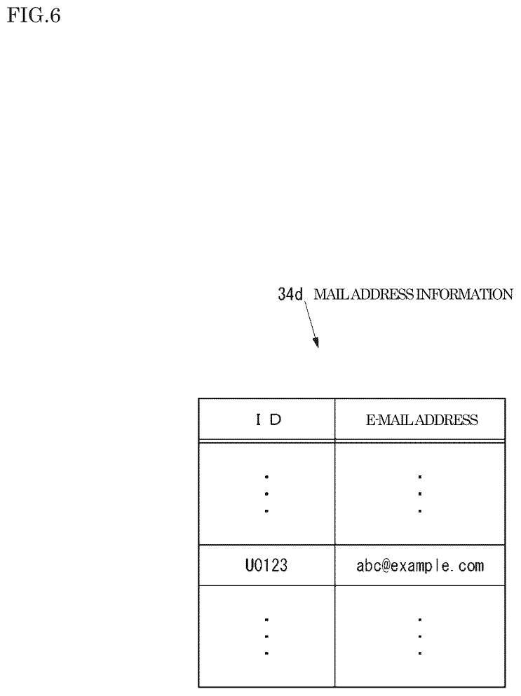

FIG. 6 is a diagram showing an example of the mail address information 34d.

The mail address information 34d shown in FIG. 6 shows, for each user, a combination of the ID of the user and an e-mail address of the user.

In FIG. 6, an illustration of IDs and e-mail addresses of users other than the user whose ID is “U0123” is omitted.

As shown in FIG. 3, the storage portion 34 includes an area 34e for recording information used for generating one-time passwords (hereinafter, will be referred to as a “generation information recording area”).

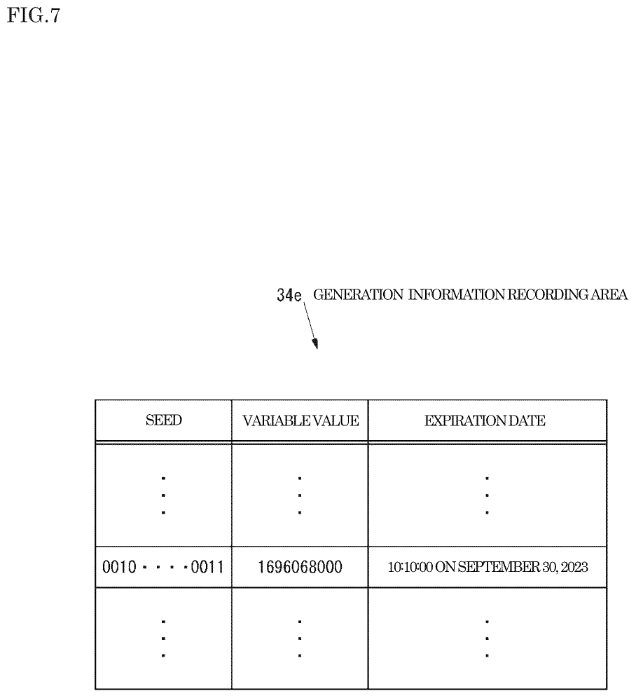

FIG. 7 is a diagram showing an example of the generation information recording area 34e.

In the generation information recording area 34e shown in FIG. 7, a combination of a seed and a variable value used for generating a one-time password and an expiration date is recorded for each seed.

In FIG. 7, an illustration of combinations other than the one combination of the seed, the variable value, and the expiration date is omitted. Out of the combination of the seed, the variable value, and the expiration date specifically illustrated in FIG. 7, the seed is illustrated while omitting a middle portion.

The generation information recording area 34e may alternatively be provided in a RAM of the control portion 35 to be described later instead of being provided in the storage portion 34.

The control portion 35 shown in FIG. 3 includes, for example, a CPU, a ROM which stores programs and various types of data, and the RAM as a memory that is used as a working area of the CPU of the control portion 35. The CPU of the control portion 35 executes the programs stored in the storage portion 34 or the ROM of the control portion 35.

The control portion 35 executes the user authentication program 34a to realize a user authentication portion 35a that executes user authentication, a one-time password generation portion 35b that generates one-time passwords, and an information management portion 35c that manages information used for generating the one-time passwords. The information management portion 35c may be, for example, Redis. The information management portion 35c may alternatively be realized by programs other than the user authentication program 34a.

Since the information processing system 30 executes user authentication, the information processing system 30 configures a user authentication system according to the present disclosure.

Next, operations of the system 10 will be described.

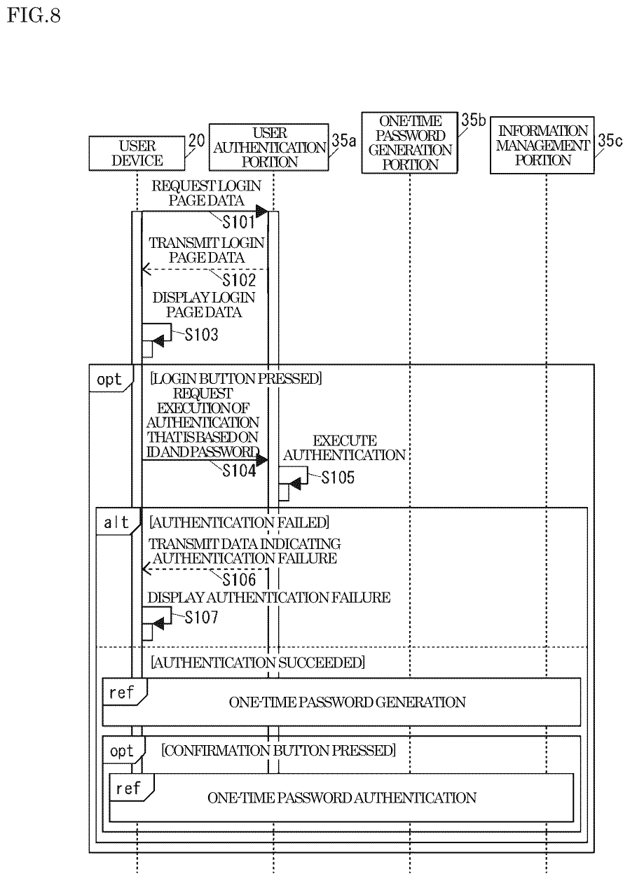

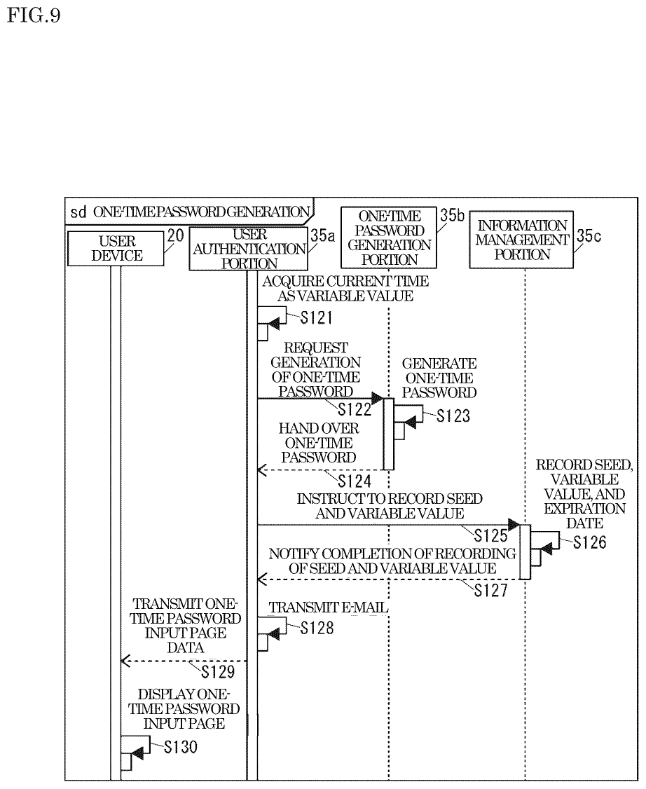

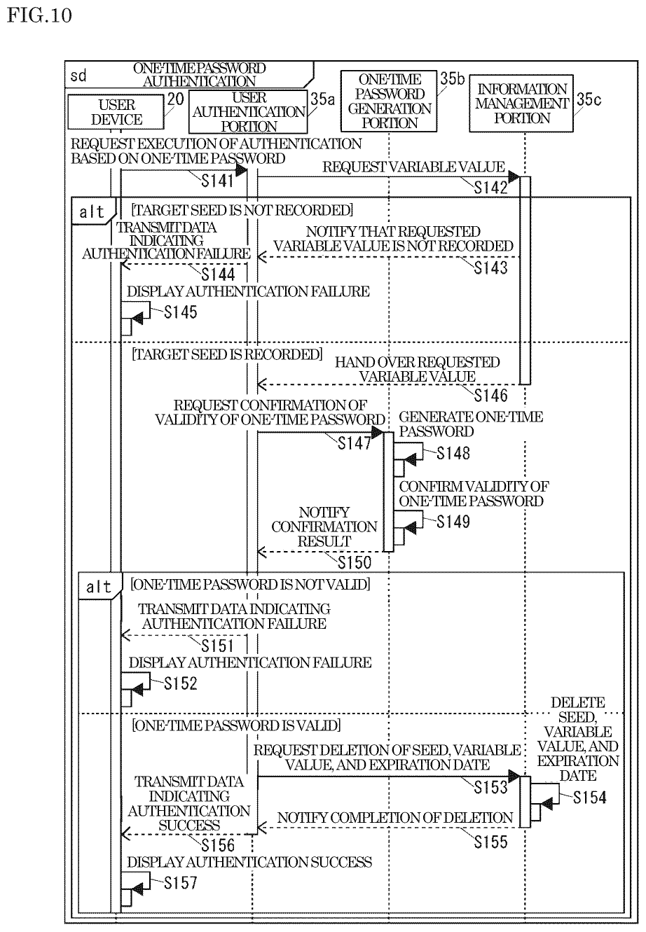

FIG. 8 is a sequence diagram showing the operations of the system 10 in a case where a user logs in to the information processing system 30. FIG. 9 is a sequence diagram for “one-time password generation” shown in FIG. 8. FIG. 10 is a sequence diagram for “one-time password authentication” shown in FIG. 8.

As a user instructs the user device 20 to access a login webpage (hereinafter, will be referred to as a “login page”) provided by the information processing system 30 via the operation portion 21 of the user device 20, the web browser 25a of the user device 20 requests the information processing system 30 for display data of the login page (hereinafter, will be referred to as “login page data”) as shown in FIG. 8 to FIG. 10 (S101).

Upon receiving the request of S101, the user authentication portion 35a of the information processing system 30 transmits the login page data to the user device 20 (S102).

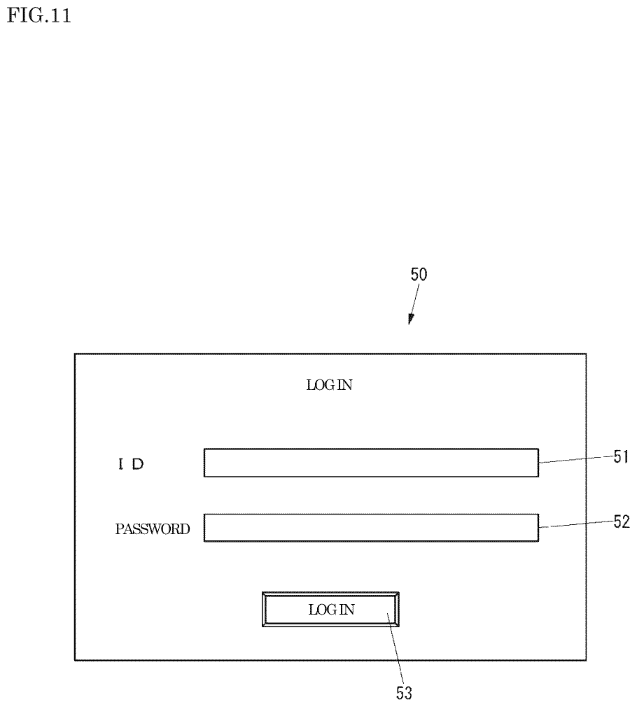

Upon receiving the login page data transmitted from the information processing system 30 in S102, the web browser 25a of the user device 20 displays a login page 50 (see FIG. 11) on the display portion 22 based on the received login page data (S103).

FIG. 11 is a diagram showing an example of the login page 50.

The login page 50 shown in FIG. 11 includes a text box 51 that is a widget for inputting an ID of a user, a text box 52 that is a widget for inputting a password of the user, and a login button 53 that is a widget for executing login.

As shown in FIG. 8 to FIG. 10, when the login button 53 is pressed, the web browser 25a of the user device 20 requests the information processing system 30 to execute authentication that is based on an ID input to the text box 51 at a time point the login button 53 has been pressed and a password input to the text box 52 at the time point the login button 53 has been pressed (S104).

Upon receiving the request of S104, the user authentication portion 35a of the information processing system 30 executes authentication that is based on the ID and password included in the request of S104 (S105). Specifically, the user authentication portion 35a determines that the authentication has succeeded when a combination of the ID and password included in the request of S104 is stored in the authentication information 34b. On the other hand, the user authentication portion 35a determines that the authentication has failed when the combination of the ID and password included in the request of S104 is not stored in the authentication information 34b.

When determining that the authentication has failed in S105, the user authentication portion 35a transmits data indicating the authentication failure to the user device 20 (S106).

Upon receiving the data transmitted from the information processing system 30 in S106, the web browser 25a of the user device 20 displays the authentication failure on the display portion 22 based on the received data (S107). Upon ending the processing of S107, the web browser 25a executes the processing of S103.

When determining that the authentication has succeeded in S105, the user authentication portion 35a of the information processing system 30 acquires a current time as a variable value to be used for generating a one-time password (S121). The current time acquired in S121 may be, for example, epoch seconds.

Upon ending the processing of S121, the user authentication portion 35a requests the one-time password generation portion 35b for generation of a one-time password that is based on a seed associated with the ID included in the request of S104 in the seed information 34c and the variable value acquired in S121 (S122).

Upon receiving the request of S122, the one-time password generation portion 35b generates a one-time password by a specific algorithm based on the seed and the variable value included in the request of S122 (S123).

Upon ending the processing of S123, the one-time password generation portion 35b hands over the one-time password generated in S123 to the user authentication portion 35a (S124).

Upon receiving the one-time password handed over from the one-time password generation portion 35b in S124, the user authentication portion 35a instructs the information management portion 35c to record the combination of the seed and the variable value included in the request of S122 while setting the combination to be deleted after an elapse of a certain period (S125). The certain period in S125 is, for example, 10 minutes. For example, when the information management portion 35c is Redis, the user authentication portion 35a stores, while attaching TTL (Time To Live), the combination of the seed and the variable value included in the request of S122 in the information management portion 35c in S125.

Upon receiving the instruction of S125, the information management portion 35c records a combination of the seed and the variable value included in the instruction of S125 and an expiration date that is based on a period included in the instruction of S125 in the generation information recording area 34e (S126). It is noted that the expiration date that is based on the period included in the instruction of S125 may be a time obtained by adding the period included in the instruction of S125 to the current time, or may be a time obtained by adding the period included in the instruction of S125 to the time acquired in S121, for example.

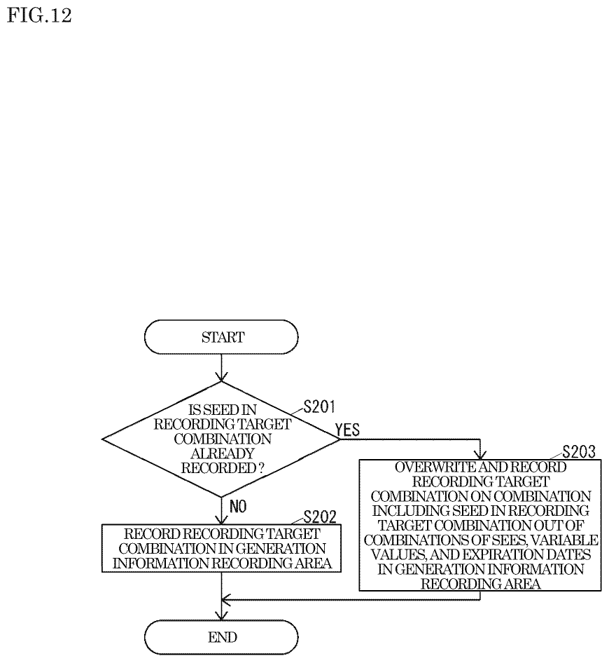

FIG. 12 is a flowchart showing operations of the information management portion 35c in a case where a combination of a seed, a variable value, and an expiration date is recorded in the generation information recording area 34e.

As shown in FIG. 12, when recording the combination of the seed, the variable value, and the expiration date in the generation information recording area 34e, the information management portion 35c determines whether or not a seed in the combination of the seed, the variable value, and the expiration date to be recorded in the generation information recording area 34e (hereinafter, will be referred to as a “recording target combination”) is already recorded in the generation information recording area 34e (S201).

When determining in S201 that the seed in the recording target combination is not yet recorded in the generation information recording area 34e, the information management portion 35c records the recording target combination in the generation information recording area 34e (S202) and ends the operations shown in FIG. 12.

When determining in S201 that the seed in the recording target combination is already recorded in the generation information recording area 34e, the information management portion 35c overwrites and records the recording target combination on a combination including the seed in the recording target combination out of the combinations of the seeds, the variable values, and the expiration dates in the generation information recording area 34e (S203), and ends the operations shown in FIG. 12.

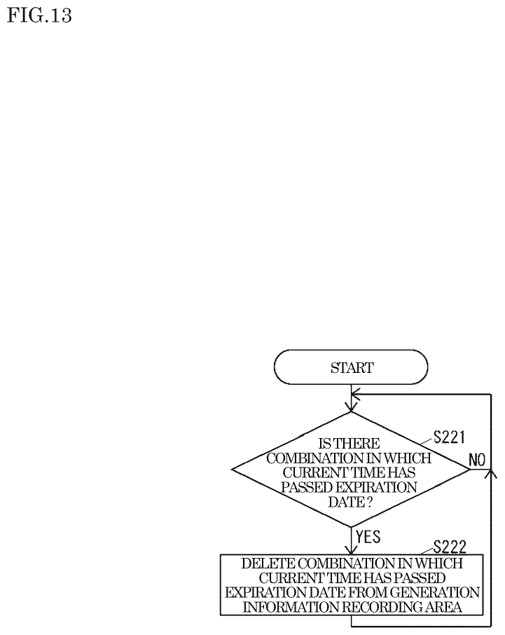

FIG. 13 is a flowchart showing the operations of the information management portion 35c in a case of deleting information with expired expiration date from the generation information recording area 34e.

As shown in FIG. 13, until determining that there exists a combination in which the current time has passed the expiration date out of the combinations of the seeds, the variable values, and the expiration dates in the generation information recording area 34e, the information management portion 35c determines whether or not there exists a combination in which the current time has passed the expiration date out of the combinations of the seeds, the variable values, and the expiration dates in the generation information recording area 34e (S221).

When determining in S221 that there exists a combination in which the current time has passed the expiration date out of the combinations of the seeds, the variable values, and the expiration dates in the generation information recording area 34e, the information management portion 35c deletes the combination in which the current time has passed the expiration date out of the combinations of the seeds, the variable values, and the expiration dates in the generation information recording area 34e from the generation information recording area 34e (S222), and executes the processing of S221.

As shown in FIG. 8 to FIG. 10, upon ending the processing of S126, the information management portion 35c notifies the user authentication portion 35a of the completion of the recording of the combination of the seed and the variable value, that corresponds to the instruction of S125 (S127).

Upon receiving the notification of S127, the user authentication portion 35a transmits an e-mail describing the one-time password handed over from the one-time password generation portion 35b in S124 to an e-mail address associated with the ID included in the request of S104 in the mail address information 34d (S128). In other words, the user authentication portion 35a notifies the one-time password generated in S123 by the e-mail.

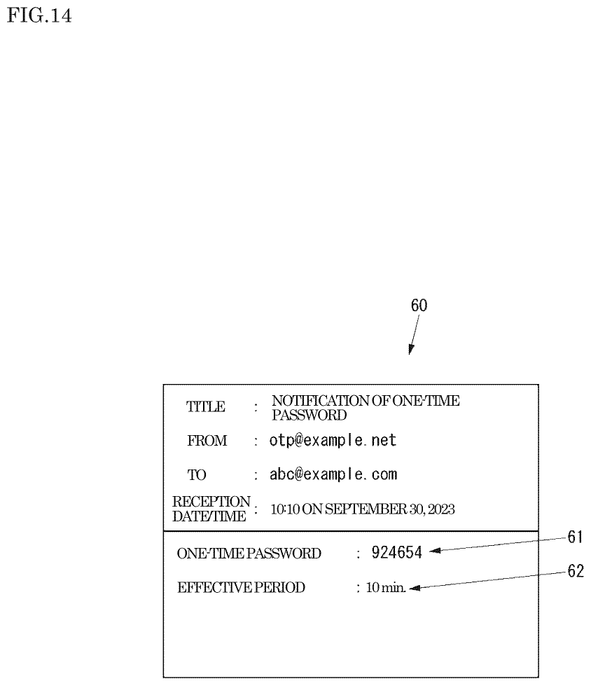

FIG. 14 is a diagram showing an example of an e-mail 60 transmitted in S128.

A text of the e-mail 60 shown in FIG. 14 includes a one-time password 61 and an effective period 62 of the one-time password.

As shown in FIG. 8 to FIG. 10, upon ending the processing of S128, the user authentication portion 35a of the information processing system 30 transmits display data of a webpage for inputting a one-time password (hereinafter, will be referred to as a “one-time password input page”) (hereinafter, will be referred to as “one-time password input page data”) to the user device 20 (S129).

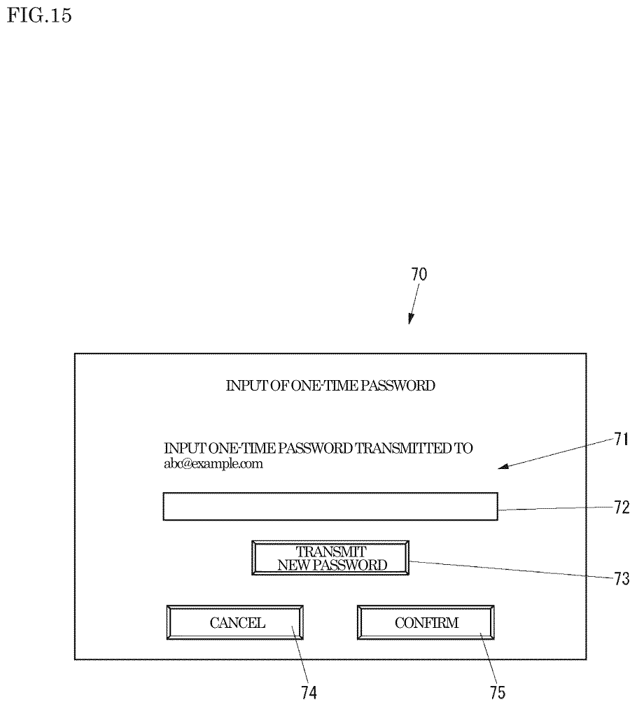

Upon receiving the one-time password input page data transmitted from the information processing system 30 in S129, the web browser 25a of the user device 20 displays a one-time password input page 70 (see FIG. 15) on the display portion 22 based on the received one-time password input page data (S130).

FIG. 15 is a diagram showing an example of the one-time password input page 70.

The one-time password input page 70 shown in FIG. 15 includes a message 71 for prompting the user to input a one-time password, a text box 72 that is a widget for inputting the one-time password, a new password transmission button 73 for transmitting a new one-time password, a cancel button 74 for canceling authentication using the one-time password, and a confirmation button 75 that is a widget for confirming the one-time password input to the text box 72.

The user authentication portion 35a of the information processing system 30 incorporates the e-mail address that is a destination of the e-mail transmitted in S128 into the message 71.

The user can input the one-time password described in the e-mail transmitted from the information processing system 30 in S128 to the text box 72.

When the new password transmission button 73 is pressed, the web browser 25a of the user device 20 notifies the information processing system 30 that the new password transmission button 73 has been pressed. Upon being notified from the user device 20 that the new password transmission button 73 has been pressed, the user authentication portion 35a of the information processing system 30 executes the processing of S121.

When the cancel button 74 is pressed, the web browser 25a of the user device 20 notifies the information processing system 30 that the cancel button 74 has been pressed. Upon being notified from the user device 20 that the cancel button 74 has been pressed, the user authentication portion 35a of the information processing system 30 executes the processing of S102.

As shown in FIG. 8 to FIG. 10, when the confirmation button 75 is pressed, the web browser 25a of the user device 20 requests the information processing system 30 to execute authentication that is based on the one-time password input to the text box 72 at a time point the confirmation button 75 has been pressed (S141).

Upon receiving the request of S141, the user authentication portion 35a of the information processing system 30 requests the information management portion 35c for a variable value recorded in association with a seed associated with the ID included in the request of S104 in the seed information 34c (S142).

When the request of S142 is received and the seed included in the request of S142 is not recorded in the generation information recording area 34e, the information management portion 35c notifies the user authentication portion 35a that the variable value requested in S142 is not recorded (S143).

Upon receiving the notification of S143, the user authentication portion 35a transmits data indicating an authentication failure to the user device 20 (S144).

Upon receiving the data transmitted from the information processing system 30 in S144, the web browser 25a of the user device 20 displays the authentication failure on the display portion 22 based on the received data (S145). Upon ending the processing of S145, the web browser 25a executes the processing of S130.

When the request of S142 is received and the seed included in the request of S142 is recorded in the generation information recording area 34e, the information management portion 35c hands over the variable value recorded in the generation information recording area 34e in association with the seed included in the request of S142 to the user authentication portion 35a (S146).

Upon receiving the variable value handed over in S146, the user authentication portion 35a requests the one-time password generation portion 35b to execute confirmation of validity of the one-time password, that is based on the received variable value, the seed associated with the ID included in the request of S104 in the seed information 34c, and the one-time password included in the request of S141 (S147).

Upon receiving the request of S147, the one-time password generation portion 35b generates a one-time password by a specific algorithm based on the seed and the variable value included in the request of S147 (S148).

Upon ending the processing of S148, the one-time password generation portion 35b confirms the validity of the one-time password based on the one-time password included in the request of S147 and the one-time password generated in S148 (S149). Specifically, the one-time password generation portion 35b determines that the one-time password is valid when the one-time password included in the request of S147 and the one-time password generated in S148 match. On the other hand, the one-time password generation portion 35b determines that the one-time password is invalid when the one-time password included in the request of S147 and the one-time password generated in S148 do not match.

Upon ending the processing of S149, the one-time password generation portion 35b notifies the user authentication portion 35a of the result of the confirmation in S149 (S150).

When the notification of S150 is received and the result of the confirmation in the received notification indicates the result that the one-time password is invalid, the user authentication portion 35a transmits data indicating an authentication failure to the user device 20 (S151).

Upon receiving the data transmitted from the information processing system 30 in S151, the web browser 25a of the user device 20 displays the authentication failure on the display portion 22 based on the received data (S152). Upon ending the processing of S152, the web browser 25a executes the processing of S130.

When the notification of S150 is received and the result of the confirmation in the received notification indicates the result that the one-time password is valid, the user authentication portion 35a requests the information management portion 35c to delete the combination of the seed, the variable value, and the expiration date, that includes the seed associated with the ID included in the request of S104 in the seed information 34c (S153).

Upon receiving the request of S153, the information management portion 35c deletes the combination of the seed, the variable value, and the expiration date, that includes the seed included in the request of S153, from the generation information recording area 34e (S154).

Upon ending the processing of S154, the information management portion 35c notifies the user authentication portion 35a of the completion of the deletion of the combination of the seed, the variable value, and the expiration date, that corresponds to the request of S153 (S155).

Upon receiving the notification of S155, the user authentication portion 35a transmits data indicating an authentication success to the user device 20 (S156).

Upon receiving the data transmitted from the information processing system 30 in S156, the web browser 25a of the user device 20 displays the authentication success on the display portion 22 based on the received data (S157).

As described heretofore, the information processing system 30 is capable of executing two-step authentication that includes executing, as a first element, What You Know that uses an ID and a password and executing, as a second element, What You Have that uses an e-mail address.

The information processing system 30 records the variable value in the generation information recording area 34e such that the variable value becomes unusable after an elapse of a specific period (S126), and when the one-time password is input, executes confirmation of validity of the input one-time password based on the input one-time password, the seed of the user, and the variable value of the user recorded in the generation information recording area 34e (S148 and S149). Thus, a one-time password having a specific period during which the variable value recorded in the generation information recording area 34e is usable, that is, a fixed effective period can be generated.

By deleting, after an elapse of the effective period (YES in S221), the variable value from the generation information recording area 34e (S222), the variable value becomes unusable after the elapse of the effective period, and thus the information processing system 30 can delete the variable value of the user whose one-time password has expired from the effective period from the generation information recording area 34e. Accordingly, the information processing system 30 can reduce a storage capacity requisite for recording the variable values as compared to HOTP in which the variable values of all users need to be recorded.

It is noted that the information processing system 30 may set the variable value to become unusable after an elapse of the effective period by methods other than the method of deleting the variable value from the generation information recording area 34e after an elapse of the effective period.

When determining by the confirmation of the validity of the input one-time password (S149) that the input one-time password is valid, the information processing system 30 sets the variable value used for the confirmation of the validity of the input one-time password to become unusable (S154), so the effective number of times of the one-time password can be limited to one with a simple configuration.

When determining by the confirmation of the validity of the input one-time password (S149) that the input one-time password is valid, the information processing system 30 deletes the variable value used for the confirmation of the validity of the input one-time password from the generation information recording area 34e (S154), to thus set the variable value used for the confirmation of the validity of the input one-time password to become unusable. Thus, the variable value used for generating the one-time password that has been used once can be deleted from the generation information recording area 34e. Accordingly, the information processing system 30 can reduce the storage capacity requisite for recording the variable values as compared to HOTP in which the variable values of all users need to be recorded.

It is noted that the information processing system 30 may set the variable value used for the confirmation of the validity of the input one-time password to become unusable by methods other than the method of deleting the variable value used for the confirmation of the validity of the input one-time password from the generation information recording area 34e.

In HOTP, a situation where the same one-time password is generated continuously may occur due to a failure in updating the variable value. However, when determining in S149 that the input one-time password is valid, the information processing system 30 deletes the variable value used in S149 from the generation information recording area 34e (S154) and records a new variable value in the generation information recording area 34e when generating a new one-time password (S126), with the result that the variable value can be updated appropriately. Accordingly, the information processing system 30 can avoid an occurrence of the situation where the same one-time password is generated continuously due to a failure in updating the variable value.

Since the value indicating the generation time of the variable value is used as the variable value, the information processing system 30 can facilitate generation of the variable value.

In HOTP, a counter value needs to be recorded as the variable value for all of the users. However, since the value indicating the generation time of the variable value is used as the variable value, the information processing system 30 does not need to record the counter value as the variable value for all of the users, and thus can reduce the storage capacity requisite for recording the variable values.

It is noted that the information processing system 30 may adopt values other than the value indicating the generation time of the variable value as the variable value.

In the present embodiment, the combination of the seed and the variable value is recorded in the generation information recording area 34e. However, the variable value may be recorded in combination with values other than the seed in the generation information recording area 34e as long as it is possible to specify which variable value belongs to what user. For example, the variable value may be recorded in combination with an ID of a user in the generation information recording area 34e.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A user authentication system, comprising:
generating a one-time password of a user based on a seed and a variable value of the user;
notifying the generated one-time password;
recording the variable value in a specific area such that the variable value becomes unusable after an elapse of a specific period; and
executing, when the one-time password is input, confirmation of validity of the input one-time password based on the input one-time password, the seed of the user, and the variable value of the user recorded in the specific area.

2. The user authentication system according to claim 1, wherein
the variable value is deleted from the specific area after the elapse of the specific period, to thus set the variable value to become unusable after the elapse of the specific period.

3. The user authentication system according to claim 1, wherein
when determined by the confirmation that the input one-time password is valid, the variable value used in the confirmation is set to become unusable.

4. The user authentication system according to claim 3, wherein
when determined by the confirmation that the input one-time password is valid, the variable value used in the confirmation is deleted from the specific area, to thus set the variable value used in the confirmation to become unusable.

5. The user authentication system according to claim 1, wherein
the variable value is a value that indicates a generation time of the variable value.

6. A computer-readable storage medium having recorded thereon a user authentication program for causing a computer to:
generate a one-time password of a user based on a seed and a variable value of the user;
notify the one-time password generated by the computer;
record the variable value in a specific area such that the variable value becomes unusable after an elapse of a specific period; and
execute, when the one-time password is input to the computer, confirmation of validity of the one-time password input to the computer based on the one-time password input to the computer, the seed of the user, and the variable value of the user recorded in the specific area.
